(19) United States
(12) Patent Application Publication
(10) Pub. No.: US 2024/0173953 A1
(43) Pub. Date: May 30, 2024

(54) METHOD AND APPARATUS FOR LAMINATING A FILM ON A SUBSTRATE

(71) Applicant: Intel Corporation, Santa Clara, CA (US)

(72) Inventors: Joshua STACEY, Chandler, AZ (US); Thomas HEATON, Gilbert, AZ (US); Dilan SENEVIRATNE, Phoenix, AZ (US)

(21) Appl. No.: 18/059,993

(22) Filed: Nov. 30, 2022

(51) Int. Cl. B32B 37/00; B32B 37/02; B32B 37/06; B32B 37/20; B32B 37/30

(52) U.S. Cl. CPC B32B 37/0007; B32B 37/02; B32B 37/065; B32B 37/20; B32B 37/30; B32B 2038/0076

(57) ABSTRACT

The present disclosure is directed to an apparatus including a first laminating component configured to laminate a dry film onto a substrate using heat, and a focused cure module configured to selectively cure a first portion of the dry film without curing a second portion of the dry film. The first portion forms a perimeter that surrounds the second portion.

### BACKGROUND

Build-up lamination of dry film in semiconductor packaging, such as standard dielectric build-up lamination, is highly susceptible to material bleed out beyond the boundaries of the starting/initial dimensions of the dry film. This can lead to downstream process contamination concerns as well as significant line yield loss. Conventional techniques to address the material bleed out include optimizing the process conditions of the lamination process to reduce bleed out. However, optimizing the process conditions of the lamination process to reduce bleed out will often result in degraded substrate flatness (e.g., total thickness variation (TTV)/C4 area thickness variation (CTV)). Other techniques include laser skiving to remove the bleed out region via ablation or edge bead removal processes using solvent/dry etch to remove the bleed out. However, laser skiving is a costly process due to both high equipment costs and low throughput. Existing laser skiving processes are also limited in the height of the bleed out that can be removed in a single pass (e.g., less than 100 um) and it is not uncommon for the height of the bleed out to exceed this threshold. As for edge bead removal processes using solvent/dry etch, these processes can be expensive and require hazardous solvents/chemistries.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the present disclosure. The dimensions of the various features or elements may be arbitrarily expanded or reduced for clarity. In the following description, various aspects of the present disclosure are described with reference to the following drawings, in which:

FIGS. 1A to 1C show simplified cross-section views of an exemplary method according to an aspect of the present disclosure;

FIG. 2 shows a simplified top view of a dry film after selective curing of a first portion of the dry film according to an aspect of the present disclosure;

FIG. 3 shows simplified cross-section views of an exemplary apparatus according to an aspect of the present disclosure; and

FIG. 4 shows another exemplary method according to an aspect of the present disclosure.

### DETAILED DESCRIPTION

The following detailed description refers to the accompanying drawings that show, by way of illustration, specific details, and aspects in which the present disclosure may be practiced. These aspects are described in sufficient detail to enable those skilled in the art to practice the present disclosure. Various aspects are provided for devices, and various aspects are provided for methods. It will be understood that the basic properties of the devices also hold for the methods and vice versa. Other aspects may be utilized and structural, and logical changes may be made without departing from the scope of the present disclosure. The various aspects are not necessarily mutually exclusive, as some aspects can be combined with one or more other aspects to form new aspects.

Various aspects of the present disclosure relate to a method and apparatus for build-up lamination. In various aspects, a method for laminating a dry film onto a substrate (or panel) is provided. The substrate may be a package substrate for semiconductor packaging. The dry film may be used for forming build up layers on the substrate. The dry film may be laminated onto a substrate in a first lamination press using heat. The first lamination press may attach the dry film onto the substrate. For example, the first lamination press may affix the dry film to the substrate. A first portion of the dry film may be selectively cured without curing a second portion of the dry film. The first portion may form a perimeter that (e.g., a peripheral portion) surrounds the second portion. In this regard, the second portion of the dry film remains uncured and flowable prior to the next processing stage.

In various aspects, an apparatus may be provided. The apparatus may include a first laminating component for laminating the dry film onto the substrate with heating for attaching the dry film onto the substrate and a focused cure module configured to selectively cure a first portion of the dry film without curing a second portion of the dry film. In an aspect, the apparatus may include a second laminating component for laminating the dry film on the substrate in a second lamination press with heating for flattening the dry film on the substrate. The focused cure module may be disposed between the first laminating component and the second laminating component.

The method and apparatus for the build-up lamination process may facilitate reducing or restricting bleeding of the dry film. The cured first portion may have a much higher viscosity than the second portion of the dry film. The cured first portion may advantageously serve as a barrier or restriction to outward flow towards the edges of the panel beyond the initial dimensions of the dry film during subsequent processing steps of the lamination (e.g., flattening steps). Accordingly, bleed out generation may be prevented.

In various aspects, edge bleed out may be significantly minimized or eliminated, further reducing or preventing panel scrap or flake-off downstream and foreign material contamination. Therefore, line yield improvements may be achieved.

In another aspect, a technical advantage of the present disclosure includes allowing more aggressive presses to improve the TTV/CTV without also increasing the amount of generated bleed out. Thus, the build-up lamination process may be improved.

In another aspect, various embodiments may obviate the need for expensive laser skiving and/or solvent/dry etch edge bead removal processes, thus reducing operational costs. Further, the need for solvents used in the wet chemistry edge bead removal process may be eliminated, thus preventing environmental health and safety concerns.

To more readily understand and put into practical effect the present carrier chuck, which may be used for panel handling, particular aspects will now be described by way of examples provided in the drawings that are not intended as limitations. The advantages and features of the aspects herein disclosed will be apparent through reference to the following descriptions relating to the accompanying drawings. Furthermore, it is to be understood that the features of the various aspects described herein are not mutually exclusive and can exist in various combinations and permutations. For the sake of brevity, duplicate descriptions of features and properties may be omitted.

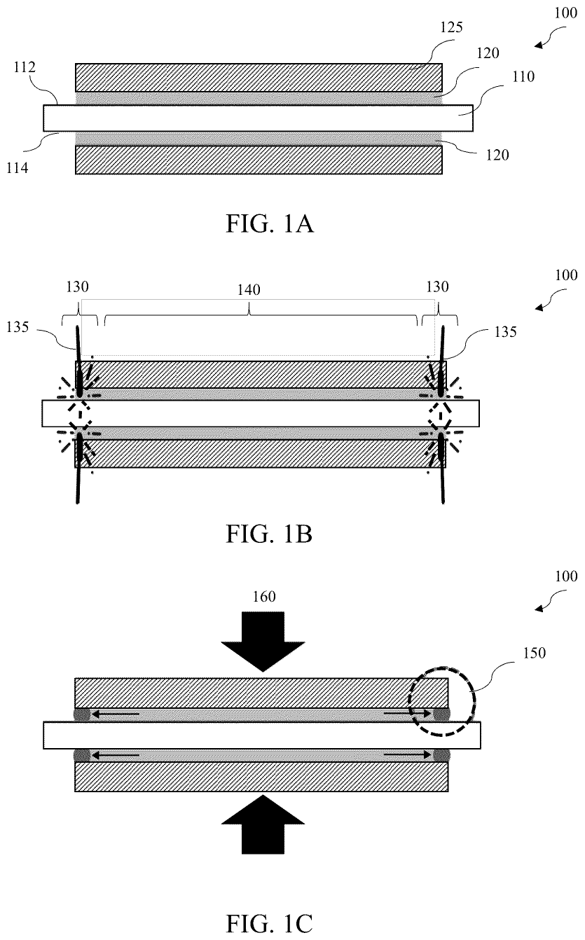

FIGS. 1A to 1C show simplified cross-section views of an exemplary method 100 according to an aspect of the present disclosure. In this aspect, the method 100 may be used for laminating a dry film 120 on a substrate 110.

The substrate 110 may be a package substrate. For example, the substrate 110 may be a pattern processed circuit substrate. In an aspect, the substrate 110 may be a core. For example, the core may be formed of inorganic or organic material. In a non-limiting example, the core may be a silica core or other glass-like materials. For example, the dry film 120 may be formed directly on the core as a buffer layer (e.g., to act as a stress buffer between the core and a subsequent copper patterning). The dry film 120 between a glass core and a first metal layer (e.g., copper) may prevent copper delamination, which could happen if the copper is disposed directly on the glass. In another aspect, the substrate 110 may include a core and conductive elements disposed on the core (not shown). In other aspects, the substrate 110 may include alternating conductive circuit layers and insulating layers (not shown).

The dry film 120 may be a dielectric material. For example, the dry film 120 may be a resin/resin-composite thermoset material that is curable at higher temperatures. The dry film 120 may be supported by a carrier 125. The carrier 125, for example, may be a polyethylene terephthalate (PET) film. The dry film 120 and the carrier 125 may be provided as a two-layer stack.

The dry film 120 may be cut to a size corresponding to the substrate 110 prior to a first lamination press. The dry film 120 may be then placed or positioned on top and bottom surfaces 112 and 114 of the substrate 110.

The dry film 120 may be laminated onto the substrate 110 in the first lamination press using heat. The first lamination press may attach the dry film 120 onto the substrate 110. Referring to FIG. 1A, the dry film 120 may be laminated on both sides of the substrate 110, such as the top and bottom surfaces 112 and 114 of the substrate 110. For example, the dry film 120 may be laminated on both sides of the substrate 110 in a single lamination step.

In an aspect, selective curing may be performed on the dry film 120. Referring to FIG. 1B, a first portion 130 of the dry film 120 may be selectively cured, without curing a second portion 140 of the dry film 120. The first portion 130 may be a peripheral portion of the dry film 120. The first portion 130 may form a perimeter that surrounds the second portion 140. In an aspect, the selective curing of the first portion 130 of the dry film 120 may be a targeted cure treatment at only the edges (e.g., peripheral or outermost portion) of the dry film 120.

As illustrated in FIG. 1C, the cured first portion 150 may have a much higher viscosity than the second portion of the dry film. The cured first portion 150 may block the flow of material of the dry film 120. Accordingly, the cured first portion 150 may reduce or restrict the outward material flow of the dry film 120 during subsequent lamination steps. Bleed out generation may be prevented during subsequent lamination steps as lamination pressure 160 is applied in a second lamination press.

In an aspect, the curing may be a partial cure such that the cured first portion 150 of the dry film 120 has a viscosity sufficient to restrict or reduce the flow of material of the dry film 120. In another aspect, the curing may be a full cure of the first portion 130 of the dry film 120.

In an aspect, the first portion 130 of the dry film 120 may be selectively cured using a laser beam 135. The laser beam 135, for example, may include infrared (IR) irradiation. For example, the dry film 120 may be selectively cured by raster scanning using the laser beam 135 over the first portion 130 of the dry film 120. In an aspect, an IR laser (not shown) may have a wavelength in the range of approximately 950 to 11,000 nm. In another aspect, the IR laser may be a CO₂ laser with a wavelength of approximately 10,600 nm. It should be understood that the laser's power and pulse time may be selected based on the processing needs for the curing process. In addition, lasers with various wavelengths may be used depending on the selected materials.

In an aspect, the laser beam 135 may be configured to heat the first portion 130 of the dry film 120 to a temperature of about 200° C. or greater.

In an aspect, the curing may be performed for a duration of about two minutes to three minutes. Accordingly, flash curing may be performed on the first portion of the dry film.

The method 100 may further include laminating the dry film 120 on the substrate 110 in the second lamination press using heat for flattening the dry film on the substrate after curing the first portion of the dry film.

In an aspect, the method 100 may include moving the substrate 110 with the dry film 120 using a transporter or carrier transport system from a first laminating component after performing the first lamination press to a focused cure module to perform the selective curing of the first portion of the dry film. The transporter may then move the substrate 110 with the dry film 120 after the selective curing to a second laminating component to perform the second lamination press. The transporter may have a conveyor mechanism for transporting the substrate or panel from stage-to-stage

It should be understood that the method 100 may include other processes, such as removing the carrier 130 from the dry film 120, which has been affixed to the substrate 110, performing a full cure of the dry film 120, including the second portion 140 of the dry film 120, and via drilling, as may be set forth in a process plan.

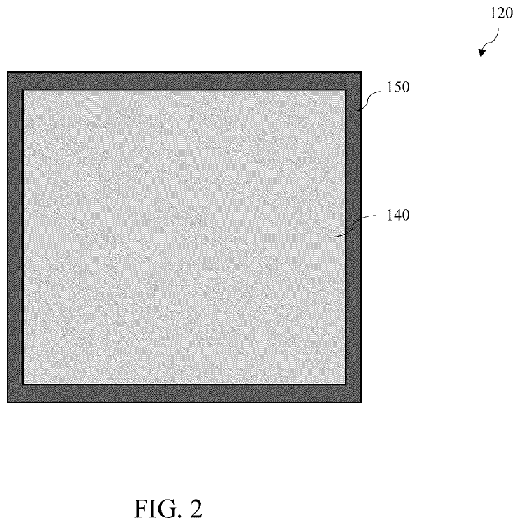

FIG. 2 shows a simplified top view of the dry film 120 after selective curing of a first portion 150 of the dry film according to an aspect of the present disclosure. As illustrated, in this aspect, the cured first portion 150 surrounds the second portion 140 of the dry film 130.

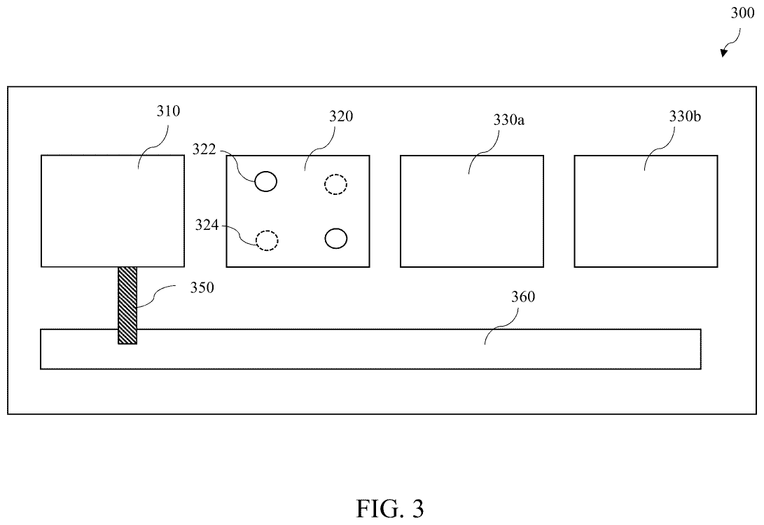

FIG. 3 shows simplified cross-section views of an exemplary apparatus 300 according to an aspect of the present disclosure.

In an aspect, the apparatus 300 may include a first laminating component 310 for laminating a dry film onto a substrate with heating for attaching the dry film onto the substrate. The first laminating component 310 may include press plates. The first laminating component 310 may be for a first lamination press stage such as, for example, rubberized press plates that apply pressure across the entire substrate at the same time. The first lamination press stage may use heat and vacuum to remove the air between the dry film and the substrate after the cut/tack process (not shown). Once the vacuum is achieved and the vacuuming process is complete, the heated press plates may be used to apply a set pressure to the substrate. Since the press plates are a rubber/compliant material, the press plates may (a) force the material of the dry film (e.g., dielectric material) to flow in and around any features (e.g., conductive pattern) on the substrate and (b) remove residual air bubbles trapped between the dry film and substrate. The first lamination press stage may be an initial conformal press and attachment of the dry film.

In an aspect, the apparatus 300 may include a focused cure module 320 configured to selectively cure a first portion of the dry film without curing a second portion of the dry film. The first portion 150 may form a perimeter that surrounds the second portion 140, as shown in FIG. 2. For example, the edges of the dry film may be selectively cured while the rest of the dry film remains uncured and flowable.

In an aspect, the focused cure module 320 may be configured to cure the first portion of the dry film using focused heating such as from a laser beam. The laser beam may include infrared irradiation. In an aspect, the focused cure module comprises top and bottom laser beam sources 322 and 324 configured to selectively cure the first portion of the dry film on first and second opposing sides of the substrate simultaneously. The laser beam sources 322 and 324 may be arranged in positions that correspond with the first portion 130 (e.g., peripheral portion) of the dry film 120, as shown in FIG. 1B. In an aspect, the focused cure module may be configured to cure the first portion of the dry film by raster scanning the laser beam over the first portion of the dry film (not shown).

In another aspect, the focused cure module 320 may be configured to cure the first portion of the dry film using concentrated contact heating. For example, the focused cure module may include metal rings (not shown) for transmitting heat to the first portion of the dry film by physical contact. The metal rings may be arranged in a position that corresponds with the first portion 130 (e.g., peripheral portion) of the dry film 120.

The focused cure module may be configured to heat the first portion of the dry film to a temperature of up to approximately 200° C. or greater as needed.

In an aspect, the focused cure module 320 may be configured to at least partially cure the first portion of the dry film. In another aspect, the focused cure module may be configured to fully cure the first portion of the dry film. The choice of the configuration may depend on the desired result that is being sought, since a partially cured first portion of the dry film may offer a degree of flexibility, whereas the fully cured first portion of the dry film may offer a greater degree of rigidity.

In an aspect, the focused cure module 320 may be configured to perform the selective curing for a duration that may be dependent on the choice of materials used, for example, approximately two minutes to three minutes. In other aspects, the focused cure module may be configured to perform selective curing for a duration of greater than three minutes. The curing of the first portion of the dry film may be a quick process to obviate negatively impacting the run rate and throughput of the lamination process.

In an aspect, the apparatus 300 may include a second laminating component 330a for laminating the dry film on the substrate (not shown) in a second lamination press using heat for flattening the dry film on the substrate. The second laminating component 330a may be for a second lamination press stage such as, for example, a metal (e.g., stainless steel) lamination press. The second lamination press stage may be for flattening the dry film on the substrate. In an aspect, the second laminating component 330a may include metal press plates (not shown). The metal press plate may be used to apply pressure to the substrate with heat to flatten the topography created in the material of the dry film from the first lamination press stage.

In an aspect, the apparatus 300 may include a third laminating component 330b for laminating the dry film on the substrate in a third lamination press using heat for flattening the dry film on the substrate. The third laminating component 330b may be for a third lamination press stage for flattening the dry film onto the substrate, which may include pressing the substrate between metal plates with heat to further flatten the substrate.

In an aspect, the apparatus 300 may include a transporter or carrier transport system 350 for moving the substrate with the dry film between the laminating component and the focused cure module. The transporter 350 may have a conveyor mechanism 360 for transporting the substrate or panel from stage-to-stage (not shown).

In an aspect, the focused cure module 320 may be incorporated in the apparatus 300 between the first laminating component 310 and the second laminating component 320 in the apparatus 300. After completion of the processing of the substrate or panel in the first laminating component 310 (or the first press stage of lamination), the substrate together with the dry film coupled to it may be transported by the transporter 350 into the focused cure module 320 where the first portion of the dry film may be cured, for example, by focused infrared or laser energy. The substrate may then proceed to the second laminating component 330a (or second press stage of lamination), and to the third laminating component 330b (or third press stage of lamination) to complete the flattening portion of the lamination processes. The cured first portion of the dry film (e.g., edges) may prevent bleed out from forming during these steps by acting as a barrier to outward flow.

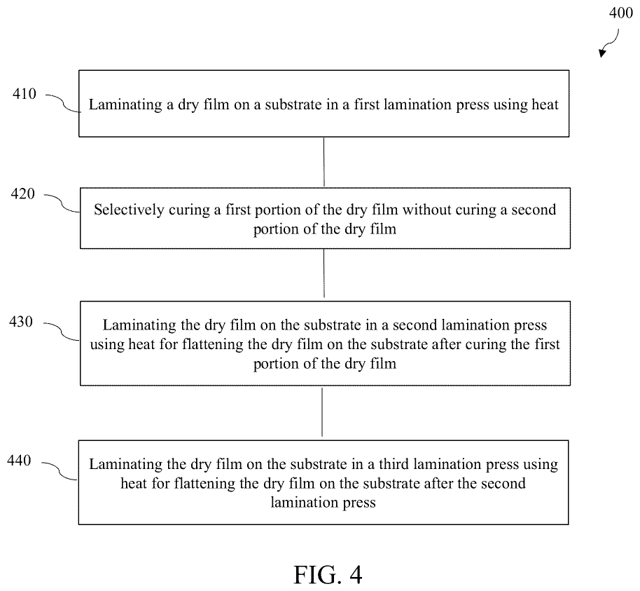

FIG. 4 shows another exemplary method 400 according to an aspect of the present disclosure. For example, the method 400 may be used for forming build up layers on a substrate.

At 410, a dry film may be laminated onto a substrate in a first lamination press using heat for attaching the dry film on the substrate. At 420, a first portion of the dry film may be selectively cured, without curing a second portion of the dry film. At 430, the dry film may be laminated on the substrate in a second lamination press using heat for flattening the dry film on the substrate after curing the first portion of the dry film. At 440, the dry film may be laminated on the substrate in a third lamination press using heat for flattening the dry film on the substrate after the second lamination press.

It will be understood that any property described herein for a specific tool may also hold for any tool or system described herein. It will also be understood that any property described herein for a specific method may hold for any of the methods described herein. Furthermore, it will be understood that for any tool, system, or method described herein, not necessarily all the components or operations described will be enclosed in the tool, system, or method, but only some (but not all) components or operations may be enclosed.

To more readily understand and put into practical effect the present carrier chuck configured to electrostatically hold or bond a panel with an electrostatic force, they will now be described by way of examples. For the sake of brevity, duplicate descriptions of features and properties may be omitted.

### EXAMPLES

Example 1 provides an apparatus including a first laminating component, configured to laminate a dry film onto a substrate using heat, and a focused cure module configured to selectively cure a first portion of the dry film without curing a second portion of the dry film, the first portion forming a perimeter that surrounds the second portion.

Example 2 may include the apparatus of example 1 and/or any other example disclosed herein, for which the focused cure module is configured to cure the first portion of the dry film using a laser beam.

Example 3 may include the apparatus of example 2 and/or any other example disclosed herein, for which the focused cure module is configured to cure the first portion of the dry film by raster scanning the laser beam over the first portion of the dry film.

Example 4 may include the apparatus of example 2 and/or any other example disclosed herein, for which the laser beam includes infrared irradiation.

Example 5 may include the apparatus of example 1 and/or any other example disclosed herein, for which the focused cure module provides heat to at least partially cure the first portion of the dry film.

Example 6 may include the apparatus of example 1 and/or any other example disclosed herein, for which the focused cure module provides heat to fully cure the first portion of the dry film.

Example 7 may include the apparatus of example 1 and/or any other example disclosed herein, for which the focused cure module includes top and bottom laser beam sources configured to selectively cure the first portion of the dry film on first and second opposing sides of the substrate simultaneously.

Example 8 may include the apparatus of example 1 and/or any other example disclosed herein, for which the focused cure module is configured to heat the first portion of the dry film to a temperature of about 200° C. or greater.

Example 9 may include the apparatus of example 1 and/or any other example disclosed herein, further including a second laminating component configured to laminate the dry film on the substrate in a second lamination press with heating for flattening the dry film on the substrate.

Example 10 may include the apparatus of example 9 and/or any other example disclosed herein, for which the focused cure module is disposed between the first laminating component and the second laminating component.

Example 11 may include the apparatus of example 10 and/or any other example disclosed herein, further including a transporter for moving the substrate with the dry film from the first laminating component to the focused cure module, and from the focused cure module to the second laminating component.

Example 12 provides a method including laminating a dry film onto a substrate in a first lamination press using heat and selectively curing a first portion of the dry film without curing a second portion of the dry film, the first portion forming a perimeter that surrounds the second portion.

Example 13 may include the method of example 12 and/or any other example disclosed herein, further including a step of further laminating the dry film on the substrate in a second lamination press using heat for flattening the dry film on the substrate after curing the first portion of the dry film.

Example 14 may include the method of example 12 and/or any other example disclosed herein, for which selectively curing the first portion of the dry film comprises using a laser beam.

Example 15 may include the method of example 14 and/or any other example disclosed herein, for which selectively curing the first portion of the dry film includes raster scanning the laser beam over the first portion of the dry film.

Example 16 may include the method of example 14 and/or any other example disclosed herein, for which the laser beam is configured to heat the first portion of the dry film to a temperature of about 200° C. or greater.

Example 17 may include the method of example 12 and/or any other example disclosed herein, for which the curing is performed for a duration of about two minutes to three minutes

Example 18 may include the method of example 12 and/or any other example disclosed herein, for which selectively curing the first portion of the dry film includes partially curing the first portion of the dry film.

Example 19 may include the method of example 12 and/or any other example disclosed herein, for which selectively curing the first portion of the dry film includes fully curing the first portion of the dry film.

Example 20 may include the method of example 12 and/or any other example disclosed herein, for which the dry film includes a dielectric material.

The term “comprising” shall be understood to have a broad meaning similar to the term “including” and will be understood to imply the inclusion of a stated integer or operation or group of integers or operations but not the exclusion of any other integer or operation or group of integers or operations. This definition also applies to variations on the term “comprising” such as “comprise” and “comprises”.

While the present disclosure has been particularly shown and described with reference to specific aspects, it should be understood by those skilled in the art that various changes in form and detail may be made therein without departing from the spirit and scope of the present disclosure as defined by the appended claims. The scope of the present disclosure is thus indicated by the appended claims and all changes which come within the meaning and range of equivalency of the claims are therefore intended to be embraced.

What is claimed is:

1. An apparatus comprising:
a first laminating component configured to laminate a dry film onto a substrate using heat; and
a focused cure module configured to selectively cure a first portion of the dry film without curing a second portion of the dry film, the first portion forming a perimeter that surrounds the second portion.

2. The apparatus of claim 1, wherein the focused cure module is configured to cure the first portion of the dry film using a laser beam.

3. The apparatus of claim 2, wherein the focused cure module is configured to cure the first portion of the dry film by raster scanning the laser beam over the first portion of the dry film.

4. The apparatus of claim 2, wherein the laser beam comprises infrared irradiation.

5. The apparatus of claim 1, wherein the focused cure module provides heat to at least partially cure the first portion of the dry film.

6. The apparatus of claim 1, wherein the focused cure module provides heat to fully cure the first portion of the dry film.

7. The apparatus of claim 1, wherein the focused cure module comprises top and bottom laser beam sources configured to selectively cure the first portion of the dry film on first and second opposing sides of the substrate simultaneously.

8. The apparatus of claim 1, wherein the focused cure module is configured to heat the first portion of the dry film to a temperature of about 200° C. or greater.

9. The apparatus of claim 1, further comprising a second laminating component configured to laminate the dry film on the substrate in a second lamination press with heating for flattening the dry film on the substrate.

10. The apparatus of claim 9, wherein the focused cure module is disposed between the first laminating component and the second laminating component.

11. The apparatus of claim 10, further comprising a transporter for moving the substrate with the dry film from the first laminating component to the focused cure module, and from the focused cure module to the second laminating component.

12. A method, comprising:
laminating a dry film onto a substrate in a first lamination press using heat; and
selectively curing a first portion of the dry film without curing a second portion of the dry film, the first portion forming a perimeter that surrounds the second portion.

13. The method of claim 12, further comprising a step of further laminating the dry film on the substrate in a second lamination press using heat for flattening the dry film on the substrate after curing the first portion of the dry film.

14. The method of claim 12, wherein selectively curing the first portion of the dry film comprises using a laser beam.

15. The method of claim 14, wherein selectively curing the first portion of the dry film comprises raster scanning the laser beam over the first portion of the dry film.

16. The method of claim 14, wherein the laser beam is configured to heat the first portion of the dry film to a temperature of about 200° C. or greater.

17. The method of claim 12, wherein the curing is performed for a duration of about two minutes to three minutes.

18. The method of claim 12, wherein selectively curing the first portion of the dry film comprises partially curing the first portion of the dry film.

19. The method of claim 12, wherein selectively curing the first portion of the dry film comprises fully curing the first portion of the dry film.

20. The method of claim 12, wherein the dry film comprises a dielectric material.
